(19) United States
(12) Patent Application Publication
(10) Pub. No.: US 2001/0047992 A1
(43) Pub. Date: Dec. 6, 2001

(54) HEATED GARMENT

(76) Inventors: ALFRED R. DEANGELIS, SPARTANBURG, SC (US); DAVID B. WILSON, BUFFALO, SC (US)

Correspondence Address: MILLIKEN & COMPANY, 920 MILLIKEN RD, PO BOX 1926, SPARTANBURG, SC, 29304, US

(21) Appl. No.: 09/457,464

(22) Filed: Dec. 8, 1999

(51) Int. Cl. H05B 3/00

(52) U.S. Cl. 219/529; 219/211; 219/212; 219/545

(57) ABSTRACT

A garment having resistance type heaters mounted thereon which are battery powered to supply heat to the wearer thereof. The heaters are fabric heaters employing conductive yarns which, when energized, provide additional warmth to a person wearing a garment on which the heaters are connected.

This invention relates generally to conductive fabrics and garments employing conductive fabrics to provide warmth to the wearer of such garments by the use of electric resistance heating supplied to the conductive fabric attached to or integrated with such garments.

Conductive fabrics are generally known and have been used for car upholstery seats, outdoor furniture and other suitable products but have not generally been employed for garments since the power systems for same have been burdensome due to the amount of power necessary to heat up the fabrics that provide the warmth to the user.

Therefore it is an object of the invention to provide a garment employing a novel conductive fabric which is lightweight, can be readily manufactured and provides sufficient heat to the user without the necessity of carrying around a heavy power pack.

Other objects, features and advantages of the invention will become readily apparent as the description proceeds to describe the invention with reference to the accompanying drawings, in which:

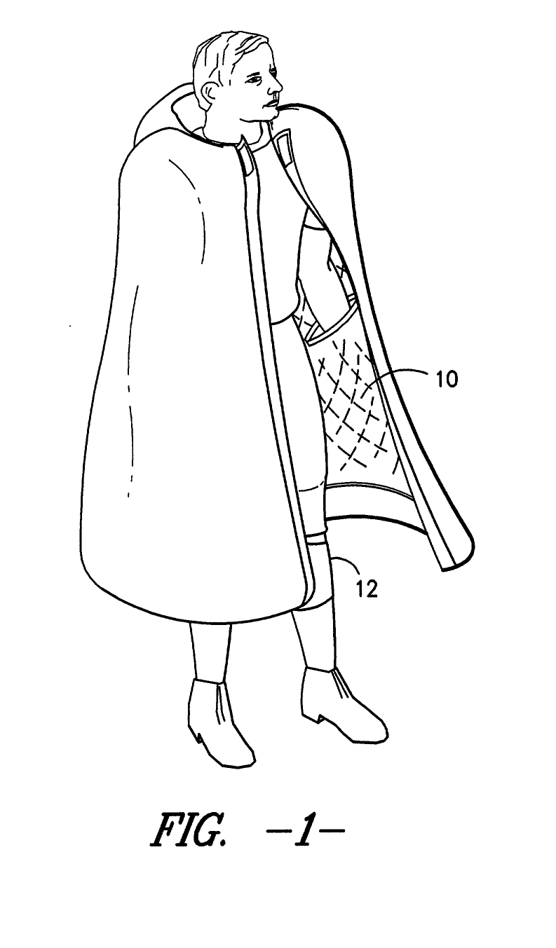

FIG. 1 shows a football player encased in the heated garment of this invention;

FIG. 2 shows the heated garment of FIG. 1, per se, with a portion opened up to show the interior thereof;

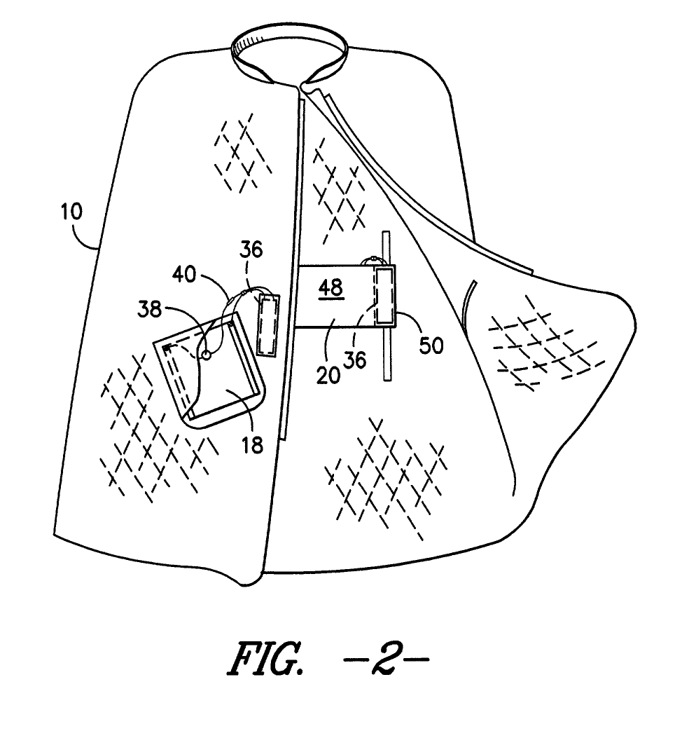

FIG. 3 is a schematic cross-sectional view of the conductive fabric;

FIG. 4 is a schematic cross-section view of one of the electrical resistance heater shown in FIG. 2; and

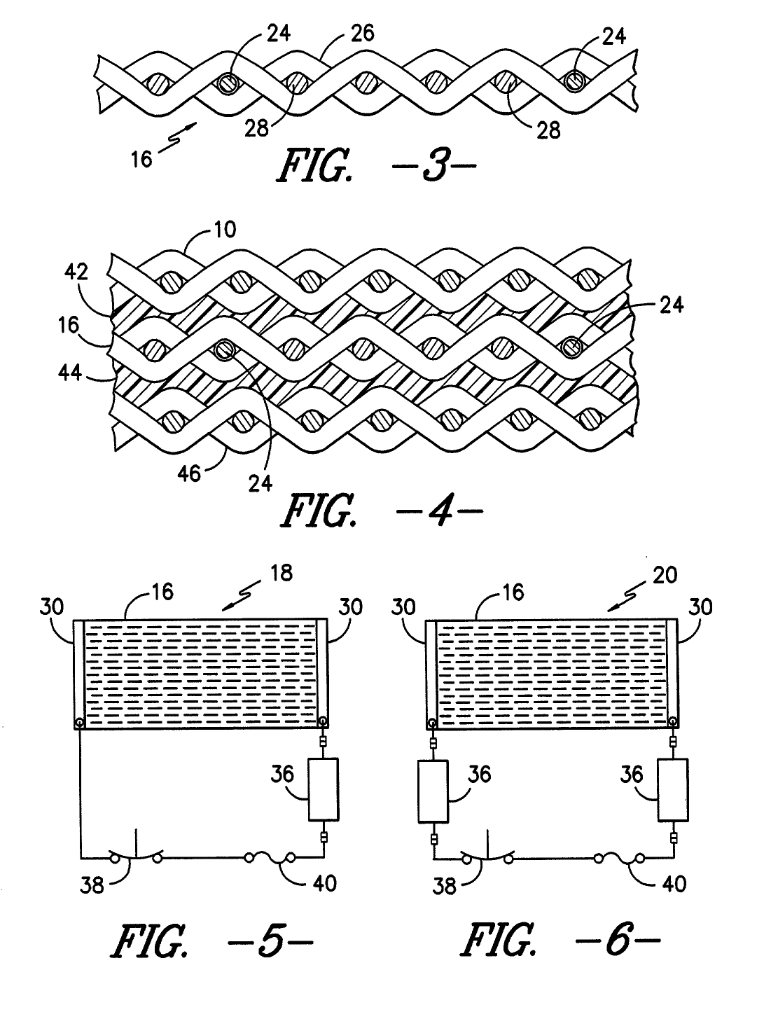

FIGS. 5 and 6 illustrate the electrical arrangements of the electrical resistance heater fabrics shown in FIG. 2.

Looking now to FIG. 1 one form of a heated garment 10 is shown wrapped around the shoulders of a football player 12. The particular garment, though preferred, is not necessarily the crux of the invention since the conductive fabric 16, (FIG. 3) can be used in other garments to provide warmth to the party wearing such garment. In FIGS. 1 and 2 the garment 10 is an inner liner for a raincoat or other outer coat and includes heaters 18 for the pockets and an elongated heater 20 for the back of the wearer.

Each of the heaters 18 and 20 employ the conductive fabric 16, which in its preferred form is woven, but can be warp knit or other suitable fabric construction. The fabric 16 is 100% polyester except for the silver coated nylon yarns 24 spaced in the fill direction to provide conductivity to the fabric. The warp yarns 26 are polyester 2/20 cotton count spun polyester while the fill yarns 28 are two ply, 250 denier 100 filament polyester. It is understood that these yarns are only exemplary since other deniers, staple yarn, etc. can be employed so long as the conductive yarn provides sufficient heat therefrom to the user of the garment to which the conductive filament is attached. The preferred conductive yarn 24 is a 210 denier silver-coated nylon filament having a resistance of 4 ohms /inch but other yarns such as stainless steel, carbon or copper sulfide coated, etc. can be employed.

As described above, it is preferred to have the conductive yarns 24 extend in the fill direction but, if desired, can extend in the warp direction. Depending on the direction the conductive yarns extend, a conductive copper tape 30 is placed on the outward edges thereof perpendicular to the conductive yarn 24. The conductive strips 30 are placed over a flexible silver ink placed on the outward edges prior to applying to the conductive copper tape 30. In some cases the flexible silver ink alone may be sufficient, or highly conductive material may be included perpendicular to the conductive yarns as part of the fabric.

Looking at FIGS. 5 and 6 typical electrical circuits are shown with FIG. 5 showing the circuit for the pocket heater 18 with one D.C. battery pack supplying 3.6 volts. FIG. 6 indicates the back warmer 20 which needs more heat so the conductive fabric 16 has two D.C. battery packs 36 in a series with the conductive copper tape 30. In principle any number of battery packs can be combined in series or parallel to provide the needed current and voltage. Each of the circuits has a thermostat 38 and a fuse 40 in series with the battery for safety purposes.

Looking now specifically to FIGS. 1, 2, and 4, the pocket warmer 18 is shown adhered to the outside of the garment 10 by a suitable adhesive 42, such as Spunfab PA1068 made by Dry Adhesive Technologies, Inc. in Cuyahoga Falls, Ohio so that when the players' hands are placed in the pockets, they will be warmed by the heater 18. Adhered to the outside of the conductive fabric 16 by another suitable film 44 is adhered a layer of any suitable protective or insulating fabric 46. The battery pack 36 therefrom is sewn or otherwise connected to the garment 10 adjacent the heater 18.

FIGS. 2 and 6 show a back warmer 20 employing the circuit shown in FIG. 6 with the conductive fabric 16 enclosed in two layers of fabric 48 and sewn or otherwise connected to the inside of the garment 10. The fabrics 48 are so constructed to provide pockets 50 at each end for the battery packs 36.

Since the batteries present a limitation on the size and output of the heaters, fabric heaters are preferred to traditional resistive-wire heaters. Whereas wire heaters require thick electrical insulation for safety and padding for comfort, fabric heaters can be put in almost direct contact with the user. Also, fabric heaters have a finer distribution of heating elements (i.e., the conductive yarns) and heat more evenly. Therefore, a fabric heater will heat more efficiently and require less power for the same effect. This reduces the battery weight, or, alternatively, allows more area to be heated for the same weight. Fabric heaters are also lighter and more flexible.

While our invention has been shown and described with reference to particular embodiments thereof, those skilled in the art will understand that other variations in form and detail may be made without departing from the scope and spirit of our invention.

We claim:

1. A heated garment comprising: a garment and a resistance type heater connected to said garment, said heater having a conductive fabric therein and a power source connected to said conductive fabric to apply current thereto.

2. The garment of claim 1 wherein said conductive fabric has spaced conductive yarns in either the warp direction or the fill direction and a conductive material connected to said conductive yarns and said power source to provide resistance heat to the wearer of said garment.

3. The garment of claim 2 wherein said heater is connected to the back of said garment.

4. The garment of claim 2 wherein said heater is connected to the pockets of said garment.

5. The garment of claim 4 wherein said pocket heater is adhered to the pockets of said garment by an adhesive or film.

6. The garment of claim 5 wherein an insulating fabric is adhered to the outside of said pocket heater.

7. The garment of claim 6 wherein a second resistance heater is connected to the back of said garment.

8. The garment of claim 7 wherein said resistance heater has two power sources in series to supply current thereto.

9. The garment of claim 2 wherein said conductive fabric is polyester with the conductive yarns being silver-coated nylon yarns.

10. The garment of claim 9 wherein said heater is connected to the pocket and back of said garment.

11. The garment of claim 10 wherein said power source is at least one D.C. battery.

12. A conductive fabric for a garment heater comprising: a plurality of intermeshed non-conductive yarns, said plurality of intermeshed yarns including a plurality of spaced conductive yarns, a conductive material connected to said conductive yarns and a power source connected to said conductive material.

13. The fabric of claim 12 wherein said intermeshed fabric is woven and the conductive yarns extend either in the warp or fill directions.

14. The fabric of claim 12 wherein said intermeshed fabric is a warp knit, weft inserted fabric and said conductive yarn is the weft inserted yarn.

15. The fabric of claim 12 wherein a film is adhered to both sides of said conductive fabric.

16. The fabric of claim 15 wherein an insulating fabric is adhered to the film on the one side of said conductive fabric.

17. A conductive fabric comprising: a plurality of intermeshed non-conductive yarns, a plurality of conductive yarns in said fabric spaced from one another and a conductive material connected to said plurality of conductive yarns.
